(19) United States
(12) Patent Application Publication
(10) Pub. No.: US 2025/0300202 A1
(43) Pub. Date: Sep. 25, 2025

(54) STARTUP CONTROL METHOD OF FUEL CELL SYSTEM

(71) Applicants: Hyundai Motor Company, Seoul (KR); Kia Corporation, Seoul (KR)

(72) Inventors: Jae Won Jung, Suwon-Si (KR); Jae Won Jang, Busan (KR); Jae Kwon Jung, Hwaseong-Si (KR); Wang Sik Jung, Suwon-Si (KR)

(21) Appl. No.: 18/811,134

(22) Filed: Aug. 21, 2024

(30) Foreign Application Priority Data
Mar. 22, 2024 (KR) 10-2024-0039756

(51) Int. Cl. H01M 8/04225; H01M 8/0438; H01M 8/04537; H01M 8/04858

(52) U.S. Cl. CPC H01M 8/04225; H01M 8/04425; H01M 8/04559; H01M 8/04589; H01M 8/04952; H01M 2250/20

(57) ABSTRACT

A startup control method of a fuel cell system includes initiating hydrogen supply to an anode, determining whether an opening degree of an air control valve (ACV having received a cut-off command, is less than or equal to a designated reference opening degree, driving an air compressor to supply bypass air, if the opening degree of the ACV is less than or equal to the reference opening degree, determining whether execution of startup cathode oxidation depletion (COD) is necessary, and if so, initiating the execution of the startup COD, and determining, depending on an integral value Q of current supplied from a fuel cell stack to a resistive electrical load, and an operating point in a current-voltage plane of a COD circuit, whether designated basic COD control, control focused on protection of the fuel cell system, or control focused on quick startup is necessary.

### CROSS-REFERENCE TO THE RELATED APPLICATION

This application claims priority to Korean Patent Application No. 10-2024-0039756, filed on Mar. 22, 2024, in the Korean Intellectual Property Office, the disclosure of which is incorporated herein by reference in its entirety.

### TECHNICAL FIELD

The present disclosure relates to technology for starting a fuel cell system, which may be mounted on a vehicle.

### BACKGROUND

A fuel cell system applied to vehicles is configured to generate electricity through an electrochemical reaction by supplying hydrogen and air to a fuel cell stack.

While the fuel cell system is stored in a stationary state, it is ideal to keep a cathode (air electrode) of the fuel cell stack airtight by closing an air control valve (ACV).

However, a malfunction of the ACV, such as poor airtightness, may occur, or air may enter the fuel cell stack due to long-term parking.

When the fuel cell system is started with air present inside the fuel cell stack, a high potential is formed at the cathode, which may cause cathode carbon corrosion.

Because the above-described cathode carbon corrosion tends to decrease as the voltage of the fuel cell stack decreases, it is desirable to connect an electrical load to the fuel cell stack to lower the voltage of the fuel cell stack when starting the fuel cell system.

When starting the fuel cell system, as described above, lowering the voltage of the fuel cell stack by connecting a resistive electrical load to the fuel cell stack is called startup cathode oxidation depletion (COD). A coolant heater (CHT) may be used as the resistive electrical load.

However, when starting the fuel cell system, if the ACV in a bypass air supply state malfunctions, such as experiencing a cut-off fault, while supplying hydrogen to an anode (hydrogen electrode), even if the above startup COD is performed, air is supplied to the fuel cell stack and the electrical load is connected to the fuel cell stack, but the voltage of the fuel cell stack becomes higher than the voltage of the load, and thus, when a main relay between the fuel cell stack and the load is connected, a phenomenon, such as damage to the main relay, may occur.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a cooling apparatus for a fuel cell system. A method may comprise: initiating, by a controller of a fuel cell system, hydrogen supply to an anode; determining, by the controller, that an opening degree of an air control valve (ACV), having received a cut-off command, is less than or equal to a reference opening degree; driving, by the controller based on the opening degree of the ACV being less than or equal to the reference opening degree, an air compressor to supply bypass air; initiating, by the controller based on an execution of startup cathode oxidation depletion (COD) being determined necessary, the execution of the startup COD; selecting, by the controller based on an integral value Q of current supplied from a fuel cell stack of the fuel cell system to a resistive electrical load and an operating point, comprising an operating current and an operating voltage, in a current-voltage plane of a COD circuit comprising the fuel cell stack connected to the resistive electrical load, a startup control comprising one or more of: a basic COD control; a protection-focused control focused on protection of the fuel cell system, or a quickness-focused control focused on quick startup; and performing, by the controller, the selected startup control.

Also, or alternatively, a control apparatus, of a fuel cell system, may comprise: a fuel cell stack; an air control valve (ACV) configured to control air supplied to a cathode of the fuel cell stack; an air compressor configured to supply air to the ACV; a resistive electrical load installed to be electrically connected to the fuel cell stack; and a controller. The controller may be configured to: initiate hydrogen supply to an anode of the fuel cell stack, drive the air compressor based on an opening degree of the ACV to supply bypass air, initiate execution of startup cathode oxidation depletion (COD); select a startup control comprising one or more of basic COD control, protection-focused control focused on protection of the fuel cell system, or quickness-focused control focused on quick startup, wherein the selecting is based on: an integral value Q of current supplied from the fuel cell stack to the resistive electrical load, and an operating point, comprising an operating current and an operating voltage, in a current-voltage plane of a COD circuit comprising the fuel cell stack connected to the resistive electrical load; and perform the selected startup control.

These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing the configuration of a fuel cell system to which a startup control method according to the present disclosure is applicable, illustrating a state in which bypass air is supplied while hydrogen is supplied;

FIG. 2 is a flowchart representing the startup control method of the fuel cell system according to the present disclosure, expressing basic COD control;

FIG. 3 is a flowchart representing a routine connected to RT1 of FIG. 2, showing protection-focused control;

FIG. 4 is a flowchart representing a routine connected to RT2 of FIG. 2, showing quickness-focused control;

FIG. 5 is a flowchart representing a routine connected to RT3 of FIG. 2, showing opening fault control;

FIG. 6 is a diagram illustrating a state in which the fuel cell system of FIG. 1 performs startup purge;

FIG. 7 is a diagram showing a state in which the fuel cell system of FIG. 1 operates while normally supplying air to a fuel cell stack;

FIG. 8 is a diagram illustrating a situation in which a cut-off fault of an ACV occurs in a state in which hydrogen and bypass air are supplied, as shown in FIG. 1;

FIG. 9 is a current-voltage graph illustrating three current-voltage lines of the fuel cell stack;

FIG. 10 is a current-voltage graph illustrating three current-voltage lines of a resistive electrical load;

FIG. 11 is a graph illustrating a current-voltage plane of a COD circuit created by combining FIG. 9 and FIG. 10;

FIG. 12 is a table expressing reference Q values assigned to a plurality of operating areas of FIG. 11;

FIG. 13 is a graph illustrating that Q5 is linearly inversely proportional to voltage;

FIG. 14 is a table illustrating that protection-focused control, quickness-focused control, or basic COD control is performed depending on the operating area of FIG. 12;

FIG. 15 is a graph illustrating that protection-focused control, quickness-focused control, and basic COD control are performed in the operating areas of the current-voltage plane of FIG. 11; and

FIG. 16 is a block diagram briefly illustrating a structure in which the fuel cell system including the fuel cell stack and a CHT is connected to a load side including a load, a converter, a high-voltage battery, and the like through a main relay.

### DETAILED DESCRIPTION

Hereinafter, examples disclosed in the present disclosure will be described in detail with reference to the accompanying drawings, the same or similar elements will be denoted by the same reference numerals even though they are depicted in different drawings, and a redundant description of these elements will be omitted.

The suffixes “module” and “part” for components used in the following description are given or used interchangeably only for ease of preparing the specification, and do not have distinct meanings or roles in themselves.

In the following description, a detailed description of known functions and configurations incorporated herein will be omitted if such description would make the subject matter of the present disclosure unclear. In addition, the accompanying drawings are only for easy understanding of the examples disclosed in this specification, and the technical idea disclosed in this specification is not limited by the accompanying drawings, and should be understood to include all changes, equivalents or substitutes included in the spirit and technical scope of the present disclosure.

In the following description of the examples, terms such as “first” and “second”, may be used to describe various elements but do not limit the elements. These terms are used only to distinguish one element from other elements.

If an element or layer is referred to as being “on,” “engaged with,” “connected to,” or “coupled to” another element or layer, it may be directly on, engaged with, connected to, or coupled to the other element or layer, or intervening elements or layers may be present. In contrast, if an element is referred to as being “directly on,” “directly engaged with,” “directly connected to,” or “directly coupled to” another element or layer, there may be no intervening elements or layers present.

Singular expressions may encompass plural expressions, unless they have clearly different contextual meanings.

In the following description of the examples, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same.

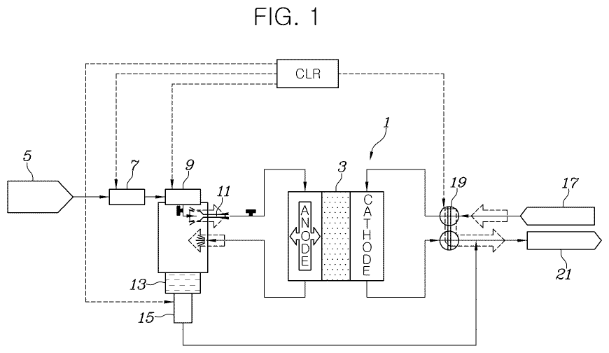

FIG. 1 shows the configuration of a fuel cell system 1 to which the present disclosure is applicable, and the fuel cell system 1 is configured such that supply of hydrogen to an anode of a fuel cell stack 3 is controlled, and supply of oxygen to a cathode of the fuel cell stack 3 is controlled.

Hydrogen supplied from a hydrogen supply source 5 is supplied to the anode through a fuel cut-off valve 7, a fuel supply valve 9, and an ejector 11, and by-products, such as hydrogen and water discharged from the anode, are discharged to the outside of the fuel cell system 1 through a water trap 13 and an integrated discharge valve 15.

Air supplied from an air compressor 17 is supplied to the cathode through an air control valve (ACV) 19, and the air supplied to the cathode is discharged to an outlet 21 through the ACV 19 again after reaction. The ACV 19 is configured not to supply a part of air supplied from the air compressor 17 to the cathode but to bypass the part of the air directly to the outlet 21 so as to form a state in which bypass air is supplied to the outlet 21.

A controller CLR is configured to control the fuel cut-off valve 7, the fuel supply valve 9, the integrated discharge valve 15, and/or the ACV 19.

For reference, FIG. 1 is a diagram illustrating a state in which hydrogen is supplied to the anode, and bypass air is supplied toward the outlet 21 while the ACV 19 cuts off air supply to the cathode.

By-products discharged from the integrated discharge valve 15 may be diluted with the bypass air or air discharged from the cathode, and then discharged into the atmosphere through the outlet 21.

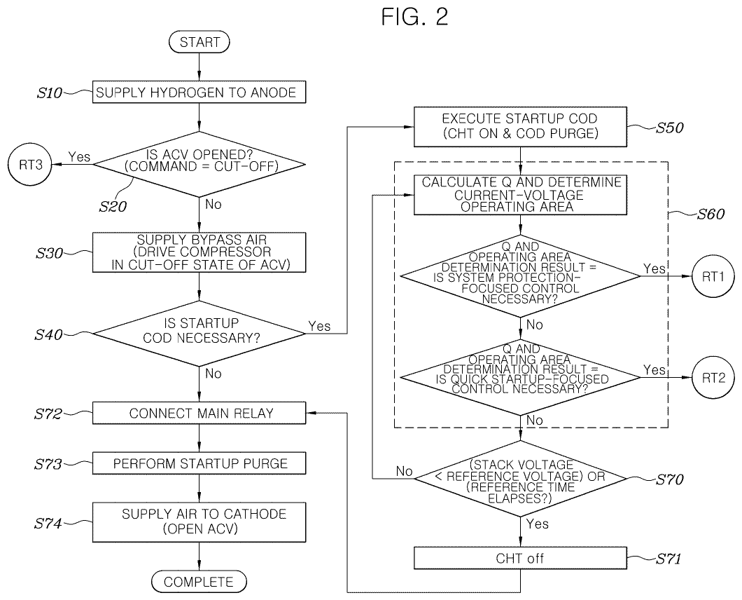

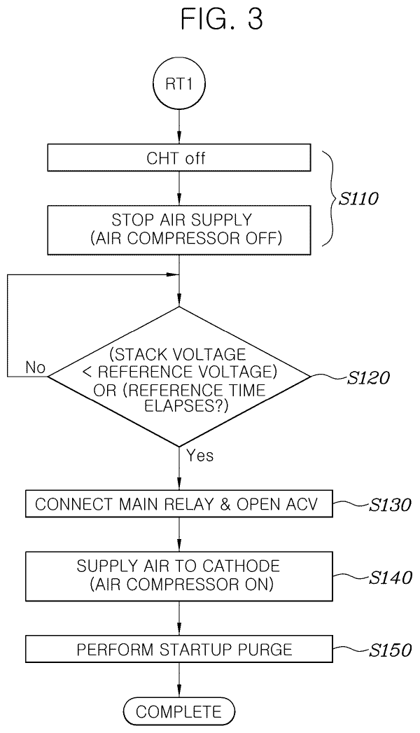

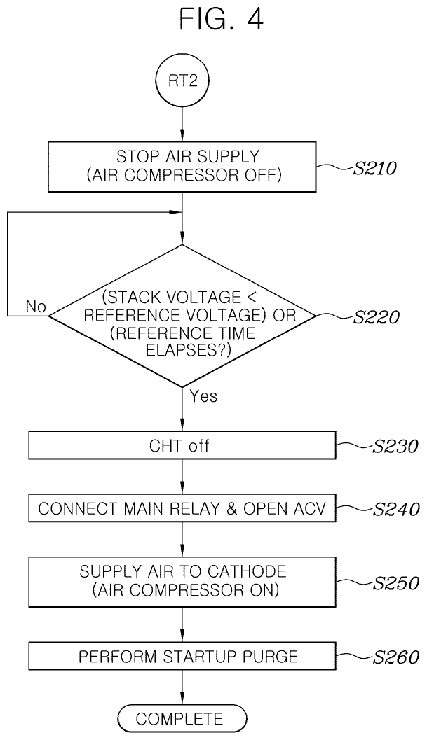

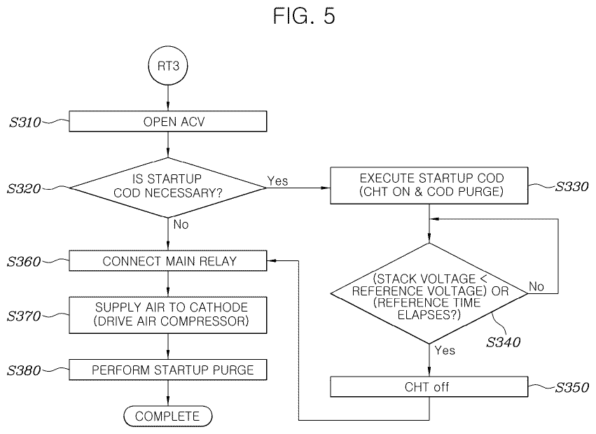

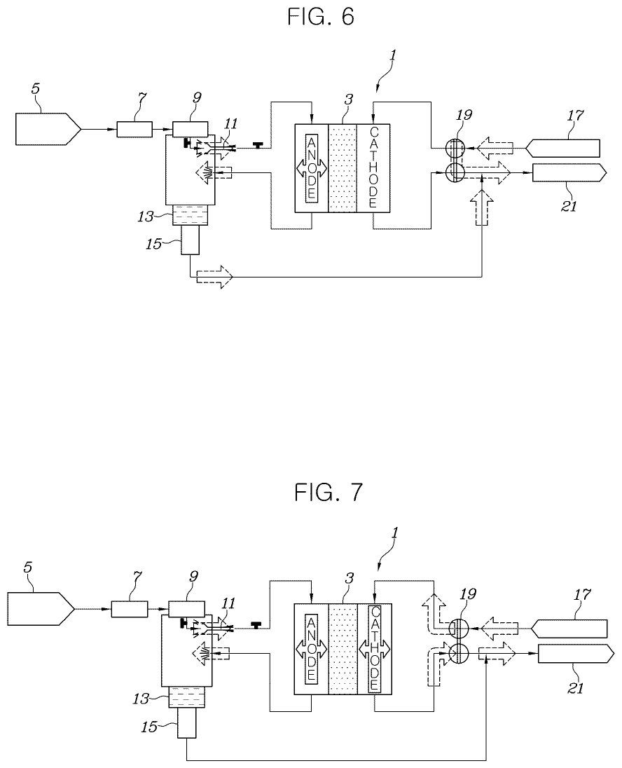

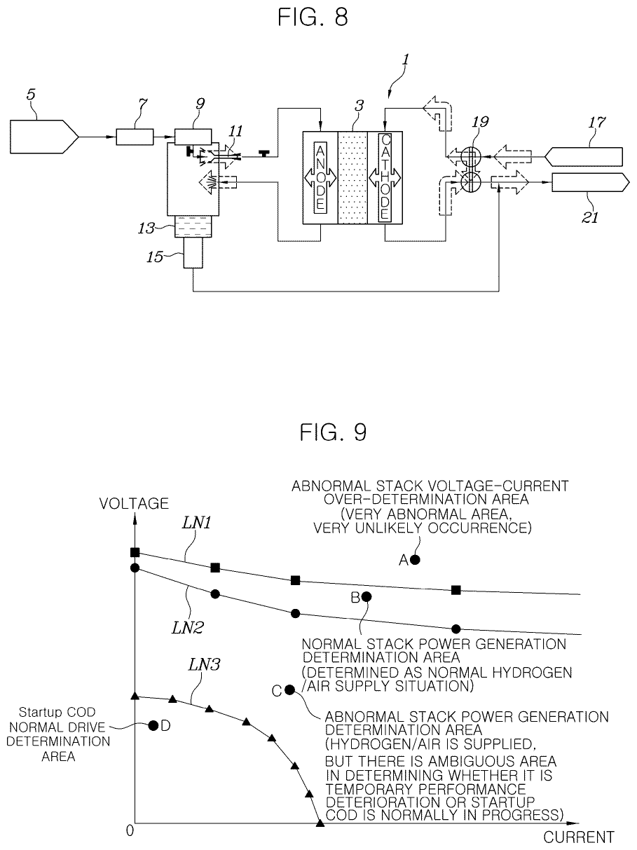

Referring to FIG. 2, FIG. 3, FIG. 4, and FIG. 5, an example of a startup control method of the fuel cell system 1 according to the present disclosure includes initiating, by the controller CLR, hydrogen supply to the anode (S10), determining, by the controller CLR, whether the opening degree of the ACV 19, in a state in which the ACV 19 has received a cut-off command, is less than or equal to a designated reference opening degree (S20), driving, by the controller CLR, the air compressor 17 to supply bypass air, if the opening degree of the ACV 19 is less than or equal to the reference opening degree (S30), determining, by the controller CLR, whether execution of startup cathode oxidation depletion (COD) is necessary (S40), initiating, by the controller CLR, the execution of the startup COD if the execution of the startup COD is necessary (S50), determining, by the controller CLR, whether designated basic COD control, protection-focused control focused on protection of the fuel cell system 1, or quick startup control focused on quick startup is necessary (e.g., selecting a control from the basic COD control, protection-focused control, or quick startup control) depending on (e.g., based on) an integral value Q of current supplied from the fuel cell stack 3 to a resistive electrical load 23 (see, e.g., FIG. 16), and an operating point, comprising an operating current and an operating voltage, in the current-voltage plane of a COD circuit comprising the fuel cell stack 3 connected to the resistive electrical load 23 (S60), performing, by the controller CLR, designated protection-focused control if it is determined that a situation requiring the control focused on protection of the fuel cell system 1 has arisen, and/or performing, by the controller CLR, designated quickness-focused control (alternately referred to as quick startup control) if it is determined that a situation requiring the control focused on quick startup of the fuel cell system 1 has arisen.

That is, in a situation in which startup of the fuel cell system 1 is initiated and hydrogen supply to the anode (e.g., a hydrogen electrode) is initiated, the controller CLR may compare the opening degree of the ACV 19, in which the cut-off command has been maintained up to now, with the reference opening degree.

The reference opening degree (e.g., 0.5°) may be determined by design through experiments and analyses to the extent that it may be confirmed whether the ACV 19 is substantially blocked depending on the cut-off command. In other words, the reference opening degree is a value that depends on the hardware specifications of the ACV or the resolution of the sensed angle value. It can be verified through experiments, and the value could be 0.5 or smaller. The term “substantial blocked” may refer to a state where the valve substantially blocks air passage (e.g., while the air passage may not be completely blocked.) For example, the valve may be considered to be effectively shut off within the system, even if a tiny amount of air passes through due to mechanical tolerances or other factors.

For reference, the opening degree of the ACV 19 compared with the reference opening degree refers to the opening degree of the ACV 19 for controlling air supplied to the cathode, not the opening degree of the ACV 19 for controlling the bypass air.

If the opening degree of the ACV 19 is less than or equal to the reference opening degree, the controller CLR, which controls the fuel cell system 1, may determine that the ACV 19 is properly cutting off the air supplied to the cathode according to the command, and may drive the air compressor 17 to supply the bypass air to the outlet 21.

Thereafter, if the voltage of the fuel cell stack 3 becomes greater than a predetermined startup COD necessity determination reference voltage to determine whether the execution of the startup COD is necessary, the controller CLR initiates the execution of the startup COD.

In the startup COD, the resistive electrical load 23 may be turned on, and designated COD purge may be performed.

Here, a coolant heater (CHT) may be used as the resistive electrical load 23, and COD purge means opening the integrated discharge valve 15 to discharge materials on the anode side for a certain period of time.

For reference, turning on the resistive electrical load 23 may mean connecting the resistive electrical load 23 to the fuel cell stack 3 so that the current of the fuel cell stack 3 flows to the resistive electrical load 23 to induce the voltage of the fuel cell stack 3 to decrease, and a circuit formed by connecting the fuel cell stack 3 and the resistive electrical load 23 is referred to as the “COD circuit”.

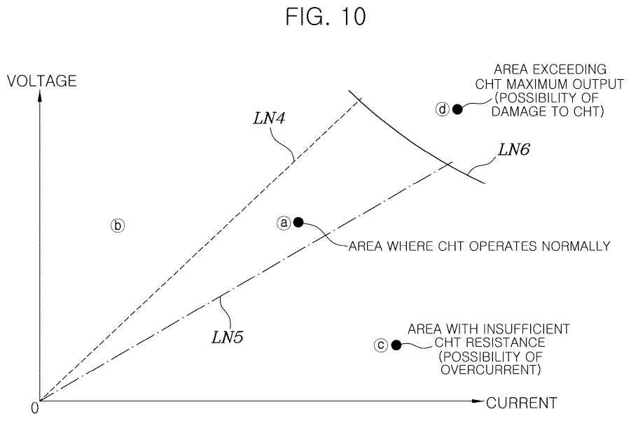

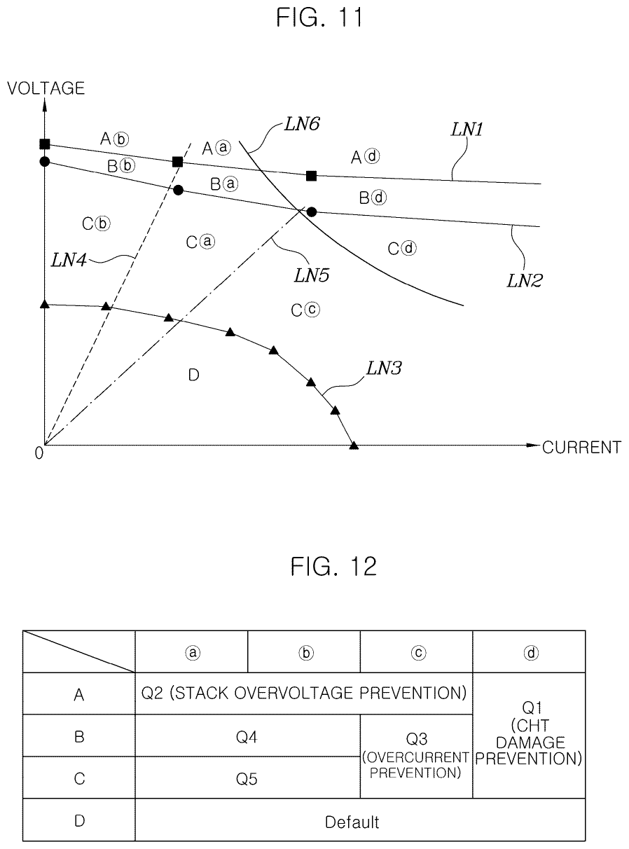

The current-voltage plane of the COD circuit comprises a plurality of operating areas, as shown in FIG. 11, defined by three current-voltage lines of the fuel cell stack 3, as shown in FIG. 9, and three current-voltage lines of the resistive electrical load 23, as shown in FIG. 10.

Further, a series of designated reference Q values may be assigned to the plurality of operating areas, as shown in FIG. 12.

The areas indicated with uppercase and lowercase alphabet letters in FIG. 9 and FIG. 10 are merged and displayed in FIG. 11, and FIG. 12 shows the reference Q values assigned to the areas indicated by the uppercase and lowercase alphabet letters.

Here, the three current-voltage lines of the fuel cell stack 3 may include a line LN1 obtained by adding a designated first decision margin to a current-voltage line of the fuel cell stack 3 in a beginning of life (BOL) state, a line LN2 obtained by subtracting a designated second decision margin from a current-voltage line of the fuel cell stack 3 in an end of life (EOL) state, and a current-voltage line LN3 of the fuel cell stack 3 where normal execution of the startup COD may be confirmed, as shown in FIG. 9.

For reference, the BOL state refers to a state in which the fuel cell stack 3 is new and exhibits optimal performance, and the EOL state refers to a state in which the fuel cell stack 3 has reached the end of the life thereof and exhibits the lowest performance. BOL and EOL may be design values determined during the development of the fuel cell stack (e.g., pre-determined values).

Further, the first decision margin and the second decision margin are physical quantities that are added and subtracted by design so as to ensure durability and stable operability of the fuel cell stack 3 for determining the operating area. For this purpose, the first decision margin and the second decision margin may be determined by design through experiments and analyses. Since the normal operating point of the fuel cell stack may be between BOL and EOL, the first decision margin can be exemplified as a value 5-10% greater than the BOL value, and the second decision margin can be exemplified as a value 5-10% less than the EOL value. The first decision margin and the second decision margin may both be set to 0, or may be set to the same value or different values.

The three current-voltage lines of the resistive electrical load 23 may include an allowable maximum output current-voltage line LN4 of the resistive electrical load 23, an allowable maximum resistance current-voltage line LN5 of the resistive electrical load 23, and an allowable minimum resistance current-voltage line LN6 of the resistive electrical load 23.

The series of reference Q values may be set as Q1<Q2<Q3<Q4<Q5, and Q5 may be set to a variable value that is linearly inversely proportional to voltage.

Q1 to Q5 are positive numbers that, as the value Q is integrated, the value Q reaches sequentially.

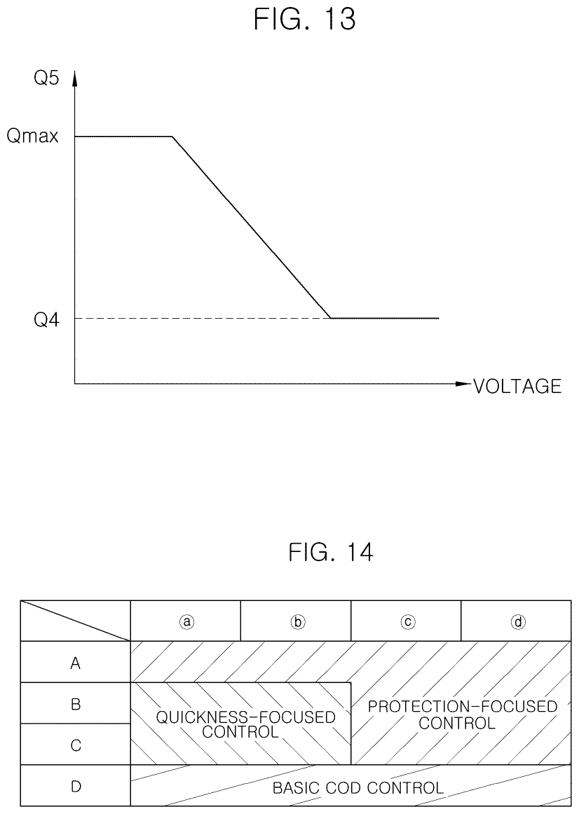

For reference, FIG. 13 is a graph illustrating that Q5 varies in linearly inverse proportion to voltage.

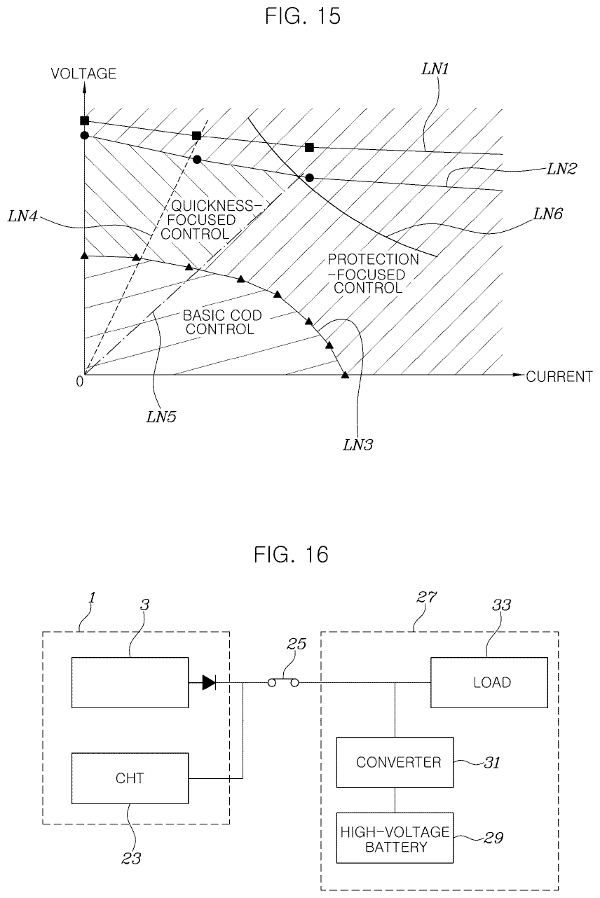

Q5 is a reference Q value assigned to an operating area in contact with the current-voltage line LN3 of the fuel cell stack 3 where the normal execution of the startup COD may be confirmed in FIG. 11, FIG. 12, FIG. 13, FIG. 14, and FIG. 15, this operating area is an area where a situation, in which it is difficult to accurately determine whether the execution of the startup COD is normal or abnormal, arises, and the lower the voltage, the more ambiguous determination as to whether the execution of the startup COD is normal or abnormal. Therefore, as shown in FIG. 13, as the voltage decreases, Q5 is set to a variable value to form a relatively higher voltage so as to improve accuracy of the determination.

As shown in FIG. 11 and FIG. 12, in the current-voltage plane of the COD circuit, relatively small reference Q values are assigned to operating areas where the current or the voltage is relatively high.

For example, in this example, Q1, which is the smallest value, is assigned to an operating area where the possibility of burnout is greatest by exceeding the maximum output of the resistive electrical load 23 so that the value Q may quickly reach Q1, thereby preventing damage to the resistive electrical load 23 through the protection-focused control, which will be described below.

An area A© and an area B© are not illustrated in FIG. 11, but the area AC and the area B© may exist depending on the current-voltage characteristics of a used fuel cell stack 3 and the current-voltage characteristics of a used resistive electrical load, and therefore, the area A© where the area A and the area © are orthogonal and the area BC where the area B and the area © are orthogonal are set forth in FIG. 12.

For example, if a fuel cell stack, where the line LN1 obtained by adding the designated first decision margin to the current-voltage line of the fuel cell stack 3 in the beginning of life (BOL) state and the line LN2 obtained by subtracting the designated second decision margin from the current-voltage line of the fuel cell stack 3 in the end of life (EOL) state are drawn further downward, is used together with the resistive electrical load 23, the area A© and the area B© may exist in FIG. 11, and therefore, FIG. 12 substantially shows this situation.

The controller CLR obtains the value Q by integrating current flowing through the COD circuit at the same time as initiating the execution of the startup COD, monitors which operating area in the current-voltage plane shown in FIG. 11 the operating point of the COD circuit belongs to, and determines whether the basic COD control, the control focused on protection of the fuel cell system 1, or the control focused on quick startup is necessary depending on the operating area to which the operating point of the COD circuit belongs and in which the value Q reaches the assigned reference Q value (S60).

Here, if it is determined that the control focused on protection of the fuel cell system 1 or the control focused on quick startup is necessary depending on the operating area to which the operating point of the COD circuit belongs and in which the value Q reaches the assigned reference Q value, the startup COD is not actually normally executed. That is, although the ACV 19 is blocked depending on the cut-off command, the opening degree of the ACV 19 is less than or equal to the reference opening degree, and the controller CLR determines that the ACV 19 normally cuts off air supplied to the cathode, unlike the detected opening degree of the ACV 19 19, air is actually supplied to the cathode due to a defect or malfunction of the ACV.

For reference, if air is not supplied to the cathode due to the opening degree of the ACV 19, which is equivalent to the opening degree of the ACV 19 if the ACV 19 is closed, without any defect or malfunction of the ACV 19, the basic COD control, which will be described later, is performed.

The above will be described in more detail with reference to FIG. 15.

In the current-voltage plane of the COD circuit, if the operating area to which the operating point of the COD circuit belongs and in which the value Q reaches the assigned reference Q value falls within an operating area below the current-voltage line LN3 of the fuel cell stack 3 where the normal execution of the startup COD may be confirmed, the basic COD control may be performed.

If the operating area to which the operating point of the COD circuit belongs and in which the value Q reaches the assigned reference Q value falls within an operating area surrounded by the current-voltage line LN3 of the fuel cell stack 3 where the normal execution of the startup COD may be confirmed, the allowable maximum resistance current-voltage line LN5 of the resistive electrical load 23, and the line LN2 obtained by subtracting the designated second decision margin from the current-voltage line of the fuel cell stack 3 in the EOL state, the quickness-focused control may be performed.

If the operating area to which the operating point of the COD circuit belongs and in which the value Q reaches the assigned reference Q value falls within remaining operating areas, the protection-focused control may be performed.

For reference, in the quickness-focused control focused on quick startup of the fuel cell system 1, the COD circuit is operated in an area of relatively higher voltage and current than the operating area in which the basic COD control is performed, but startup of the fuel cell system 1 is promoted quickly compared to the case in which the protection-focused control is performed, in a situation in which the protection-focused control focused on protection of the fuel cell system 1 is not required.

The protection-focused control is configured to sequentially perform, as shown in FIG. 3, turning off the resistive electrical load 23 and the air compressor 17 (S110), standing by until the voltage of the fuel cell stack 3 becomes less than a designated drop completion reference voltage or a designated reference time elapses (S120), connecting a main relay 25 and opening the ACV 19, if standing by is completed (S130), turning on the air compressor 17 to supply air to the cathode (S140), and performing startup purge (S150).

That is, because the operating point of the COD circuit belongs to an operating area where there is a risk of damage to the resistive electrical load 23, or the like, the value Q reaches Q1 assigned to this operating area, and thus, there is a risk of damage to the resistive electrical load 23, the resistive electrical load 23 is immediately turned off and the air compressor 17 is turned off to cut off unintentional supply of air to the cathode of the fuel cell stack 3.

If the air supplied to the cathode is stopped, as described above, the voltage of the fuel cell stack 3 drops over time, and eventually becomes less than the drop completion reference voltage, and the drop completion reference voltage is a voltage which does not cause damage to the main relay 25 or the like even though the main relay 25 is turned on to connect a load side 27 to the fuel cell system 1. Therefore, if the voltage of the fuel cell stack 3 becomes less than the drop completion reference voltage, the main relay 25 is connected and the remaining starting tasks are performed, thereby completing startup of the fuel cell system 1.

Accordingly, the drop completion reference voltage may be determined by design through a number of experiments and analyses depending on the above-described purpose.

Further, the reference time is a time for maintaining the resistive electrical load 23 in the on state if executing the startup COD, that is, a predetermined time to turn off the resistive electrical load 23 if this time elapses, even if the voltage of the fuel cell stack 3 does not drop below the drop completion reference voltage due to the execution of the startup COD.

Therefore, the reference time is set to a level to ensure a sufficient time for the voltage of the fuel cell stack 3 to drop below the drop completion reference voltage due to the execution of the startup COD, but not to cause excessive delay in starting the fuel cell system 1, and may be determined by design through a number of experiments and analyses.

Here, the remaining starting tasks, performed after connecting the main relay 25, are to open the ACV 19 and turn on the air compressor 17 to supply air to the cathode of the fuel cell stack 3, and to perform the startup purge.

Here, the startup purge means to open the integrated discharge valve 15 for a certain time to discharge unnecessary substances from the anode of the fuel cell stack 3, similar to the COD purge, so as to ensure the hydrogen concentration of the anode at an appropriate level.

The quickness-focused control is configured to sequentially perform, as shown in FIG. 4, turning off the air compressor 17 (S210), standing by until the voltage of the fuel cell stack 3 becomes less than the drop completion reference voltage or the reference time elapses (S220), turning off the resistive electrical load 23, if standing by is completed (S230), connecting the main relay 25 and opening the ACV 19 (S240), turning on the air compressor 17 to supply air to the cathode (S250), and performing the startup purge (S260).

That is, if the operating point of the COD circuit does not belong to the operating area where there is a risk of damage to the resistive electrical load 23, or the like, and belongs to operating areas indicating normal operation of the fuel cell stack 3 and operating areas of lower voltage and current than the former operating areas, and the value Q reaches a corresponding reference Q value among Q2, Q3, Q4, and Q5 assigned to these operating areas, the air compressor 17 is turned off to cut off unintentional supply of air to the cathode so that unintended air no longer flows to the cathode of the fuel cell stack 3, and the resistive electrical load 23 is maintained in the on state, so as to allow the voltage of the fuel cell stack to more quickly drop below the drop completion reference voltage.

If the voltage of the fuel cell stack 3 becomes less than the drop completion reference voltage, the resistive electrical load 23 is turned off, the air compressor 17 is turned on, and the startup purge is performed, thereby completing startup of the fuel cell system 1.

If it is determined that neither the control focused on protection of the fuel cell system 1 nor the control focused on quick startup is necessary by determining the operating point of the COD circuit and whether the value Q reaches the reference Q value belonging to the operating point (S60), the basic COD control is performed below.

That is, the basic COD control is configured to sequentially perform standing by until the voltage of the fuel cell stack 3 becomes less than the drop completion reference voltage or the reference time elapses (S70), turning off the resistive electrical load 23, if standing by is completed (S71), connecting the main relay 25 (S72), performing the startup purge (S73), and opening the ACV 19 (S74).

In conclusion, as shown in FIG. 2, in the basic COD control, after executing the startup COD, if the voltage of the fuel cell stack 3 becomes less than the drop completion reference voltage, the resistive electrical load 23 is turned off, the main relay 25 is connected, the startup purge is performed, and the ACV 19 is opened to supply air to the cathode, thereby completing startup of the fuel cell system 1.

In determining whether or not the execution of the startup COD is necessary (S40), if it is determined that the execution of the startup COD is not necessary, the operation of connecting the main relay 25 is directly performed and then the subsequent operations are performed, thereby completing startup of the fuel cell system 1.

In determining whether the opening degree of the ACV 19 in the state in which the ACV 19 has received the cut-off command, is less than or equal to the designated reference opening degree (S20), if it is determined that the opening degree of the ACV 19 exceeds the reference opening degree, the following opening fault control is performed.

That is, the opening fault control is configured to sequentially perform, as shown in FIG. 5, opening the ACV 19 (S310), determining whether the execution of the startup COD is necessary (S320), initiating the execution of the startup COD, if the execution of the startup COD is necessary (S330), standing by until the voltage of the fuel cell stack 3 becomes less than the drop completion reference voltage or the reference time elapses (S340), turning off the resistive electrical load 23, if standing by is completed (S350), connecting the main relay 25 (S360), driving the air compressor 17 (S370), and performing the startup purge (S380).

If the opening degree of the ACV 19 exceeds the reference opening degree even though the ACV 19 is in the state of having received the cut-off command, it is determined that the ACV 19 malfunctions due to a cut-off fault, and thus, bypass air will not be supplied to the outlet 21, as described above. Therefore, the ACV 19 is opened in advance to minimize the startup delay as much as possible, the startup COD is executed if the voltage of the fuel cell stack 3 becomes greater than the startup COD necessity determination reference voltage, the resistive electrical load 23 is turned off if the voltage of the fuel cell stack 3 becomes less than the drop completion reference voltage, the main relay 25 is connected to connect the load side 27 to the fuel cell system 1, the air compressor 17 is driven, and the startup purge is performed, thereby completing startup of the fuel cell system 1.

For reference, as shown in FIG. 16, based on the main relay 25, the resistive electrical load 23 is a component included in the fuel cell system 1, and the load side 27 may include a high-voltage battery 29, a converter 31, and a load 33 (e.g., an device to be driven by the fuel cell system 1 (e.g., an engine, a driving motor of an vehicle) is distinguished from the resistive electrical load 23.

A fuel cell system control apparatus, which performs the above-described control method according to the present disclosure, includes the fuel cell stack 3, the ACV 19 configured to control air supplied to the cathode of the fuel cell stack 3, the air compressor 17 configured to supply air to the ACV 19, the resistive electrical load 23 installed to be electrically connected to the fuel cell stack 3, and the controller CLR configured to initiate hydrogen supply to the anode, drive the air compressor 17 considering the opening degree of the ACV 19 to supply bypass air, initiate execution of the startup COD if the execution of the startup COD is necessary, determine whether designated basic COD control, control focused on protection of the fuel cell system 1, or control focused on quick startup is necessary depending on the integral value Q of current supplied from the fuel cell stack 3 to the resistive electrical load 23, and the operating point in the current-voltage plane of the COD circuit in which the fuel cell stack 3 and the resistive electrical load 23 are connected, and perform the control determined as necessary, if starting the fuel cell system 1.

The present disclosure has been made in view of the above problems, and others in the field. An object of the present disclosure is to provide a startup control method, of a fuel cell system, that prevents damage to a main relay caused by a malfunction, such as a cut-off fault of an air control valve (ACV), when starting the fuel cell system.

The above and other objects can be accomplished by the provision of a startup control method of a fuel cell system including initiating, by a controller, hydrogen supply to an anode, determining, by the controller, whether an opening degree of an ACV, in a state of having received a cut-off command, is less than or equal to a designated reference opening degree, driving, by the controller, an air compressor to supply bypass air, if the opening degree of the ACV is less than or equal to the reference opening degree, determining, by the controller, whether execution of startup COD is necessary, initiating, by the controller, the execution of the startup COD if the execution of the startup COD is necessary, determining, by the controller, whether designated basic COD control, control focused on protection of the fuel cell system, or control focused on quick startup is necessary depending on an integral value Q of current supplied from a fuel cell stack to a resistive electrical load, and an operating point in a current-voltage plane of a COD circuit in which the fuel cell stack and the resistive electrical load are connected, performing, by the controller, designated protection-focused control if it is determined that a situation requiring the control focused on protection of the fuel cell system has arisen, and performing, by the controller, designated quickness-focused control if it is determined that a situation requiring the control focused on quick startup of the fuel cell system has arisen.

The current-voltage plane of the COD circuit may be divided into a plurality of operating areas by three current-voltage lines of the fuel cell stack and three current-voltage lines of the resistive electrical load, a series of designated reference Q values may be assigned to the plurality of operating areas, and whether the basic COD control, the control focused on protection of the fuel cell system, or the control focused on quick startup is necessary may be determined depending on an operating area to which the operating point of the COD circuit and in which the value Q reaches an assigned reference Q value.

The three current-voltage lines of the fuel cell stack may include a line obtained by adding a designated first decision margin to a current-voltage line of the fuel cell stack in a BOL state, a line obtained by subtracting a designated second decision margin from a current-voltage line of the fuel cell stack in an EOL state, and a current-voltage line of the fuel cell stack where normal execution of the startup COD may be confirmed.

The three current-voltage lines of the resistive electrical load may include an allowable maximum output current-voltage line of the resistive electrical load, an allowable maximum resistance current-voltage line of the resistive electrical load, and an allowable minimum resistance current-voltage line of the resistive electrical load.

The series of reference Q values may be set as Q1<Q2<Q3<Q4<Q5, and Q5 may be set to a variable value that is linearly inversely proportional to voltage.

In the current-voltage plane of the COD circuit, relatively small reference Q values may be assigned to operating areas where current or voltage is relatively high.

In the current-voltage plane of the COD circuit, when (if) the operating area to which the operating point of the COD circuit belongs and in which the value Q reaches the assigned reference Q value falls within an operating area below the current-voltage line of the fuel cell stack where the normal execution of the startup COD may be confirmed, the basic COD control may be performed, when (if) the operating area to which the operating point of the COD circuit belongs and in which the value Q reaches the assigned reference Q value falls within an operating area surrounded by the current-voltage line of the fuel cell stack where the normal execution of the startup COD may be confirmed, the allowable maximum resistance current-voltage line of the resistive electrical load, and the line obtained by subtracting the designated second decision margin from the current-voltage line of the fuel cell stack in the EOL state, the quickness-focused control may be performed, and when (if) the operating area to which the operating point of the COD circuit belongs and in which the value Q reaches the assigned reference Q value falls within remaining operating areas, the protection-focused control may be performed.

In the quickness-focused control focused on quick startup of the fuel cell system, the COD circuit may be operated in an area of relatively higher voltage and current than the operating area in which the basic COD control is performed, but startup of the fuel cell system may be promoted quickly compared to a case in which the protection-focused control is performed, in a situation in which the protection-focused control focused on protection of the fuel cell system is not required.

The protection-focused control may be configured to sequentially perform turning off the resistive electrical load and an air compressor, standing by until voltage of the fuel cell stack becomes less than a designated drop completion reference voltage or a designated reference time elapses, connecting a main relay and opening the ACV, when standing by is completed, turning on the air compressor to supply air to a cathode, and performing startup purge.

The quickness-focused control may be configured to sequentially perform turning off the air compressor, standing by until the voltage of the fuel cell stack becomes less than the drop completion reference voltage or the reference time elapses, turning off the resistive electrical load, when (if) standing by is completed, connecting the main relay and opening the ACV, turning on the air compressor to supply air to the cathode, and performing the startup purge.

If it is determined that neither the control focused on protection of the fuel cell system nor the control focused on quick startup is necessary, the basic COD control may be performed, and the basic COD control may be configured to sequentially perform standing by until the voltage of the fuel cell stack becomes less than the drop completion reference voltage or the reference time elapses, turning off the resistive electrical load, when (if) standing by is completed, connecting the main relay, performing the startup purge, and opening the ACV.

In determining whether or not the execution of the startup COD is necessary, if it is determined that the execution of the startup COD is not necessary, connecting the main relay may be directly performed.

The startup control method may be configured to sequentially perform opening the ACV, if the opening degree of the ACV exceeds the reference opening degree, determining whether the execution of the startup COD is necessary, initiating the execution of the startup COD, if the execution of the startup COD is necessary, standing by until the voltage of the fuel cell stack becomes less than the drop completion reference voltage or the reference time elapses, turning off the resistive electrical load, when (if) standing by is completed, connecting the main relay, driving the air compressor, and performing the startup purge.

In the startup COD, the resistive electrical load may be turned on, and designated COD purge may be performed.

In accordance with another aspect of the present disclosure, there is provided a control apparatus of a fuel cell system including a fuel cell stack, an ACV configured to control air supplied to a cathode of the fuel cell stack, an air compressor configured to supply air to the ACV, a resistive electrical load installed to be electrically connected to the fuel cell stack, and a controller configured to initiate hydrogen supply to an anode of the fuel cell stack, drive the air compressor considering an opening degree of the ACV to supply bypass air, initiate execution of startup COD if the execution of the startup COD is necessary, determine whether designated basic COD control, control focused on protection of the fuel cell system, or control focused on quick startup is necessary depending on an integral value Q of current supplied from the fuel cell stack to the resistive electrical load and an operating point in a current-voltage plane of a COD circuit in which the fuel cell stack and the resistive electrical load are connected, and perform the control determined as necessary, when starting the fuel cell system.

The current-voltage plane of the COD circuit may be divided into a plurality of operating areas by three current-voltage lines of the fuel cell stack and three current-voltage lines of the resistive electrical load, a series of designated reference Q values may be assigned to the plurality of operating areas, and whether the basic COD control, the control focused on protection of the fuel cell system, or the control focused on quick startup is necessary may be determined depending on an operating area to which the operating point of the COD circuit and in which the value Q reaches an assigned reference Q value.

The three current-voltage lines of the fuel cell stack may include a line obtained by adding a designated first decision margin to a current-voltage line of the fuel cell stack in a BOL state, a line obtained by subtracting a designated second decision margin from a current-voltage line of the fuel cell stack in an EOL state, and a current-voltage line of the fuel cell stack where normal execution of the startup COD may be confirmed, and the three current-voltage lines of the resistive electrical load may include an allowable maximum output current-voltage line of the resistive electrical load, an allowable maximum resistance current-voltage line of the resistive electrical load, and an allowable minimum resistance current-voltage line of the resistive electrical load.

The series of reference Q values may be set as Q1<Q2<Q3<Q4<Q5, and Q5 may be set to a variable value that is linearly inversely proportional to voltage.

The controller may be configured to perform protection-focused control, if it is determined that the control focused on protection of the fuel cell system is necessary, and the protection-focused control may be configured to sequentially perform turning off the resistive electrical load and an air compressor, standing by until voltage of the fuel cell stack becomes less than a designated drop completion reference voltage or a designated reference time elapses, connecting a main relay and opening the ACV, when (if) standing by is completed, turning on the air compressor to supply air to a cathode, and performing startup purge.

The controller may be configured to perform quickness-focused control, if it is determined that the control focused on quick startup of the fuel cell system is necessary, and the quickness-focused control may be configured to sequentially perform turning off the air compressor, standing by until voltage of the fuel cell stack becomes less than a designated drop completion reference voltage or a designated reference time elapses, turning off the resistive electrical load, when (if) standing by is completed, connecting the main relay and opening the ACV, turning on the air compressor to supply air to the cathode, and performing startup purge.

As is apparent from the above description, the present disclosure prevents damage to a main relay caused by a malfunction, such as a cut-off fault of an ACV while ensuring that a fuel cell system may be started as quickly as possible, if starting the fuel cell system.

While the present disclosure has been explained in relation to specific examples, it is to be understood that various modifications and changes thereof will become apparent to those skilled in the art without departing from the technical spirit of the present disclosure as provided by the appended claims.

What is claimed is:

1. A method comprising:
initiating, by a controller of a fuel cell system, hydrogen supply to an anode;
determining, by the controller, that an opening degree of an air control valve (ACV), having received a cut-off command, is less than or equal to a reference opening degree;
driving, by the controller based on the opening degree of the ACV being less than or equal to the reference opening degree, an air compressor to supply bypass air;
determining, by the controller, whether an execution of startup cathode oxidation depletion (COD) is necessary;
initiating, by the controller based on the execution of COD being determined necessary, the execution of the startup COD;
selecting, by the controller based on an integral value Q of current supplied from a fuel cell stack of the fuel cell system to a resistive electrical load and an operating point, comprising an operating current and an operating voltage, in a current-voltage plane of a COD circuit comprising the fuel cell stack connected to the resistive electrical load, a startup control comprising one or more of:
a basic COD control;
a protection-focused control focused on protection of the fuel cell system, or
a quickness-focused control focused on quick startup; and
performing, by the controller, the selected startup control.

2. The method of claim 1, wherein:
the operating point is from one of a plurality of operating areas defined by three current-voltage lines of the fuel cell stack and three current-voltage lines of the resistive electrical load;
a plurality of reference Q values is assigned to the plurality of operating areas; and
the selecting the startup control is based on an operating area to which the operating point of the COD circuit belongs and assigned a reference Q value, of the plurality of reference Q values, that the integral value Q reaches.

3. The method of claim 2, wherein the three current-voltage lines of the fuel cell stack comprise:
a line obtained by adding a designated first decision margin to a current-voltage line of the fuel cell stack in a beginning of life (BOL) state;
a line obtained by subtracting a designated second decision margin from a current-voltage line of the fuel cell stack in an end of life (EOL) state; and
a current-voltage line of the fuel cell stack associated with normal execution of the startup COD.

4. The method of claim 3, wherein the three current-voltage lines of the resistive electrical load comprise:
an allowable maximum output current-voltage line of the resistive electrical load;
an allowable maximum resistance current-voltage line of the resistive electrical load; and
an allowable minimum resistance current-voltage line of the resistive electrical load.

5. The method of claim 4, wherein:
the plurality of reference Q values comprises Q1, Q2, Q3, Q4, and Q5, wherein Q1<Q2<Q3<Q4<Q5; and
Q5 is inversely proportional to the operating voltage.

6. The method of claim 5, wherein smaller reference Q values are assigned to operating areas having higher current or voltage.

7. The method of claim 4, wherein the selecting the startup control comprises one or more of:
based on the operating area, to which the operating point of the COD circuit belongs and assigned the reference Q value that the value Q reaches, being in a first area below and bounded by the current-voltage line of the fuel cell stack associated with normal execution of the startup COD, selecting the basic COD control;
based on the operating area, to which the operating point of the COD circuit belongs and assigned the reference Q value that the value Q reaches, being within a second area bounded by the current-voltage line of the fuel cell stack associated with normal execution of the startup COD, the allowable maximum resistance current-voltage line of the resistive electrical load, and the line obtained by subtracting the designated second decision margin from the current-voltage line of the fuel cell stack in the EOL state, selecting the quickness-focused control; or
based on the operating area, to which the operating point of the COD circuit belongs and assigned the reference Q value that the value Q reaches, being within a third area outside of the first area and the second area, selecting the protection-focused control.

8. The method of claim 7, wherein the second area has relatively higher voltage and current than the first area.

9. The method of claim 1, wherein the protection-focused control is configured to cause:
turning off the resistive electrical load and the air compressor;
standing by until one or more of:
voltage of the fuel cell stack becomes less than a designated drop completion reference voltage; or
a designated reference time elapses;
after the standing by:
connecting a main relay; and
opening the ACV;
turning on the air compressor configured to supply air to a cathode; and
performing a startup purge.

10. The method of claim 1, wherein the quickness-focused control is configured to cause:
turning off the air compressor;
standing by until one or more of:
a voltage of the fuel cell stack becomes less than a drop completion reference voltage or
a reference time elapses;
after the standing by, turning off the resistive electrical load;
connecting a main relay and opening the ACV;
turning on the air compressor to supply air to the cathode; and
performing a startup purge.

11. The method of claim 1, wherein the basic COD control is configured to cause:
standing by until one or more of:
a voltage of the fuel cell stack becomes less than a drop completion reference voltage; or
a reference time elapses;
after the standing by, turning off the resistive electrical load;
connecting a main relay;
performing a startup purge; and
opening the ACV.

12. The method of claim 1, further comprising, based on determining that the execution of the startup COD is not necessary,
connecting a main relay without performing the startup COD;
performing a startup purge; and
opening the ACV.

13. The method of claim 1, further comprising:
based on a second opening degree of the ACV exceeding the reference opening degree, opening the ACV;
initiating a second execution of the startup COD;
standing by until one or more of:
a voltage of the fuel cell stack becomes less than a drop completion reference voltage; or
a reference time elapses;
after the standing by, turning off the resistive electrical load;
connecting a main relay;
driving the air compressor; and
performing a startup purge.

14. The method of claim 1, wherein the resistive electrical load is turned on and a designated COD purge is performed.

15. A control apparatus of a fuel cell system comprising:
a fuel cell stack;
an air control valve (ACV) configured to control air supplied to a cathode of the fuel cell stack;
an air compressor configured to supply air to the ACV;
a resistive electrical load installed to be electrically connected to the fuel cell stack; and
a controller configured to:
initiate hydrogen supply to an anode of the fuel cell stack,
drive the air compressor based on an opening degree of the ACV to supply bypass air,
initiate execution of startup cathode oxidation depletion (COD);
select a startup control comprising one or more of basic COD control, protection-focused control focused on protection of the fuel cell system, or quickness-focused control focused on quick startup, wherein the selecting is based on:
an integral value Q of current supplied from the fuel cell stack to the resistive electrical load, and
an operating point, comprising an operating current and an operating voltage, in a current-voltage plane of a COD circuit comprising the fuel cell stack connected to the resistive electrical load;
and
perform the selected startup control.

16. The control apparatus according to claim 15, wherein:
the operating point is from one of a plurality of operating areas defined by three current-voltage lines of the fuel cell stack and three current-voltage lines of the resistive electrical load;
a plurality of reference Q values is assigned to the plurality of operating areas; and
the controller is configured to select the one or more of the basic COD control, the protection-focused control, or the quickness-focused control based on an operating area to which the operating point of the COD circuit belongs and assigned a reference Q value, of the plurality of reference Q values, that the reference value Q reaches.

17. The control apparatus according to claim 16, wherein:
the three current-voltage lines of the fuel cell stack comprise:
a line obtained by adding a designated first decision margin to a current-voltage line of the fuel cell stack in a beginning of life (BOL) state;
a line obtained by subtracting a designated second decision margin from a current-voltage line of the fuel cell stack in an end of life (EOL) state; and
a current-voltage line of the fuel cell stack associated with normal execution of the startup COD; and
the three current-voltage lines of the resistive electrical load comprise:
an allowable maximum output current-voltage line of the resistive electrical load;
an allowable maximum resistance current-voltage line of the resistive electrical load; and
an allowable minimum resistance current-voltage line of the resistive electrical load.

18. The control apparatus according to claim 16, wherein:
the plurality of reference Q values comprises Q1, Q2, Q3, Q4, and Q5, wherein Q1<Q2<Q3<Q4<Q5; and
Q5 is inversely proportional to the operating voltage.

19. The control apparatus according to claim 15, wherein the controller is configured to perform protection-focused control by causing:
turning off the resistive electrical load and the air compressor;
standing by until one or more of:
a voltage of the fuel cell stack becomes less than a designated drop completion reference voltage; or
a designated reference time elapses;
after the standing by:
connecting a main relay; and
opening the ACV;
turning on the air compressor to supply air to a cathode; and
performing a startup purge.

20. The control apparatus according to claim 15, wherein the controller is configured to perform quickness-focused control by causing:
turning off the air compressor;
standing by until one or more of:
a voltage of the fuel cell stack becomes less than a designated drop completion reference voltage; or
a designated reference time elapses;
after the standing by, turning off the resistive electrical load;
connecting a main relay;
opening the ACV;
turning on the air compressor to supply air to the cathode; and
performing a startup purge.
